(19) United States
(12) Patent Application Publication
(10) Pub. No.: US 2004/0126731 A1
(43) Pub. Date: Jul. 1, 2004

(54) Clutch transfer device

(75) Inventors: John H. Tucker, Fairview, PA (US); Timothy M. Barber, Waterford, PA (US); William P. Legler, Erie, PA (US)

Correspondence Address: Robert V. Vickers, Esq., Fay, Sharpe, Fagan, Minnich & McKee, LLP, 7th Floor, 1100 Superior Avenue, Cleveland, OH, 44114-2518, US

(73) Assignee: TBL Partnership

(21) Appl. No.: 10/624,365

(22) Filed: Jul. 22, 2003

Related U.S. Application Data
(60) Provisional application No. 60/425,783, filed on Nov. 13, 2002.
(60) Provisional application No. 60/416,791, filed on Oct. 8, 2002.

(51) Int. Cl. A61C 19/04

(52) U.S. Cl. 433/68

(57) ABSTRACT

A transfer device for use with a dental articulator which includes a plate member and a base member spaced apart from the plate member. The base member is adapted to be received by an articulator. A stem is connected to the plate member and extends between the plate member and the base member. A column extends from a first surface of the base member. The stem is pivotally received in an opening of the column. A retaining block has an opening for receiving the column.

### BACKGROUND OF THE INVENTION

The present invention relates to a universal and clutch transfer device. More particularly, the present invention relates to a clutch transfer device for use with a bite fork and clutch which are used with a dental articulator.

Dental articulators are commonly utilized in the dental field to obtain articulation corresponding to the difference between maxillary and mandibular teeth of a particular individual. In order to construct an acceptable prosthesis, dental casts of the patients' maxillary and mandibular arches are mounted in a dental articulator in order that the maxillary and mandibular casts are maintained in the same relationship as in the mouth of the patient.

Devices are used for recording information concerning the optimal esthetic position and angulation of the anterior teeth of a dental patient as an aid to the restoration of teeth with crowns or the construction of dental prostheses. Crowns or prostheses are fabricated in a dental laboratory on models of a patient's ridges or prepared teeth. These models are mounted on an articulator, usually with the aid of a face bow. Pantograph or check bite recordings may be used to set up the controls of the articulator to duplicate the movement of the patient's jaw. The system provides the dental technician with much of the information he or she needs regarding chewing function, and other functional parameters. Detailed information is also needed on the correct alignment and placement of teeth relative to the patient's face to produce an appearance harmonious with the patient's face, i.e., the esthetic parameters.

A bite fork is typically used to be inserted into the patient's mouth and secured to a face bow by tightening screws on a clamp. A mix of soft registration material, such as a plaster or polyether paste is injected between the maxillary teeth and the bite fork. Alternatively, several gobs or pieces of wax are placed on the bite fork to obtain the impression of the patent's anterior teeth. The face bow is held steady until the registration material sets, and is then removed from the patient and a check is performed for a clear impression of the teeth. The bite fork is clamped or screwed into position on a clutch with respect to the face bow and the user's mouth and is indexed to determine the correct angulation and position of the upper teeth of the user.

The bite fork is mounted to a clutch which typically includes a base block and a vertical rod fixed to the base block. The bite fork has a stem which fits into a hole in the rod. The clutch in turn is mounted on a facebow with a posterior portion of its base block in a central section of a bracket of the facebow.

The facebow is fitted to the patient with earplugs firmly inserted into the patient's ears and the bite fork is inserted into the mouth. The facebow is pivoted upwards around the ear plugs until the stem of the bite fork contacts the incisal edges of the maxillary centered incisors or lies at the level that they should occupy. A mix of soft registration material, such as a polyether paste, is injected between the maxillary teeth and the bite fork. The facebow is held steady until the registration material sets, and is then removed from the patient and is checked for a clear impression of the teeth. The bite fork and clutch assembly is taken off the facebow and is sent to the laboratory for mounting of a maxillary model and onto an articulator.

A problem that occurs is that when the bite fork and clutch assembly is sent to the laboratory for use with the articulator, the setting of the fork may be slightly altered or misaligned due to loosening during shipment of the bite fork to the laboratory. Consequently, an error may occur in the positioning and setting of the prostheses for the patient's teeth. Furthermore, it is desirable to ship the clutch and bite fork to the laboratory without also providing the articulator to the lab.

Accordingly, it is desirable to develop a new and improved universal and clutch transfer device which would overcome the foregoing deficiencies and others while meeting the above stated needs and providing better and more advantageous overall results.

### SUMMARY OF THE INVENTION

The present invention relates to a new and improved clutch transfer device. In particular, the present invention relates to a transfer device for use with a dental articulator, having a plate member, and a base member spaced apart from the plate member the base member is adapted to be received by an articulator. A stem is connected to the plate member and extends between the plate member and the base member. A column extends from a first surface of the base member. The stem is pivotally received in an opening of the column. A retaining block comprises a first opening for receiving the column, and a second opening disposed substantially perpendicular to the first opening for receiving a fastener.

In accordance with another aspect of the present invention, on articulator assembly has an articulator base having a plurality of pins oriented around a magnetized section and a bite fork and jig assembly.

The bite fork and jig include a block, a rod adjustably fixed to the block, and a bite fork comprising a U-shaped plate and a stem. The bite fork is removably clamped to the rod via a mounting support extending from the rod and receiving the stem. The mounting support has a clamp assembly. The base further has an opening for receiving the rod of the jig assembly. The articulator assembly also has a transfer device including a base member adapted to be received by the articulator base; and a plate member pivotally connected to the base member via a stem. The plate member is adapted to align with and be removably secured to an underside of the bite fork plate. A retaining member receives the stem and locks a position of the plate member into place.

In accordance with yet another aspect of the invention a transfer device has an upper plate and a lower plate connected to the upper plate via a stem. The stem is fastened to the upper plate and is pivotally received by an opening in the lower plate. A retaining element is provided for locking the stem and the upper plate in a particular position.

According to yet another aspect of the present invention, a clutch transfer device has a plate; and a support member secured to the plate. A magnetized member is positioned on a first surface of the support. At least one pin is received by a hole in the first surface of the support member. A recess is formed in the first surface of the support member. The hole and the magnetized member are positioned in the recess.

Specifically, the clutch transfer device includes a universal transfer device and a clutch transfer table. The universal transfer device has a pivotable upper plate, attached to a stem with a universal ball joint which fits into a base. The base has a bottom plate with a magnet and a series of holes which engage pins on various model articulators. Thus, the transfer device is universal in that it can be used with a variety of conventional articulators. A screw or other suitable fastening means is used to lock the ball joint and stem in place when the upper plate is aligned with a bite fork. Plaster or polyvinyl type material is placed between the underside of the bite fork and the upper side of the upper plate of the transfer device to connect them together and secure the correct alignment between the universal transfer device upper plate and the bite fork. Once the universal transfer device upper plate is properly indexed to the bite fork, the two are separated and then shipped together to the laboratory for use with an articulator. Since the position of the transfer device upper plate is locked into place, the orientation and position of the bite fork is preserved by the position of the upper plate of the universal transfer device. Thus, if the bite fork orientation is slightly misaligned during shipment, the fork is re-indexed using the transfer device.

When the universal transfer device arrives at the laboratory, the device is mounted onto the articulator by aligning the holes in the base with pins in the articulator base and the magnet engages a corresponding magnet on the articulator base. The bite fork and clutch are also mounted onto the articulator and a U-shaped plate of the bite fork is aligned or indexed with the upper plate of the universal transfer device.

The universal transfer device has a universal base or mounting plate which corresponds to several commercially available articulators such as those made by Teledyne™ or Denar™. Alternatively, the universal transfer device may be used with a clutch transfer table. The clutch transfer table, which is configured to duplicate the articulator base of a specific articulator model, includes a top member, a plate, and two legs which may be fitted into slots screwed into place or machined as one piece with the clutch transfer table. The top member has a magnet and several holes which replicate the magnet and base of a specific model of articulator. The top member can have several spaced apart finger grips or cut-outs to facilitate installing the universal transfer device onto the table. The clutch table also has a extension member with a hole for receiving the rod of the clutch and a clamp for securing the clutch within the hole.

The clutch transfer table top member replicates a specific type of articulator base, such as one made by Denar™, and thus can only be used with the corresponding clutch and facebow of the corresponding Denar™ articulator. Different clutch tables will have different top members to corresponding to different articulators.

The clutch transfer table can be available at the lab, thus eliminating the need for a dentist to ship the articulator to the lab. Thus, the articulator would remain available to the dentist, reducing the number of articulators that the dentist need procure. The universal transfer device is installed onto the top member of the clutch table. Arrows on the top member and the base of the universal transfer device are aligned. The clutch rod is inserted into the corresponding hole of the clutch table and is secured into place.

The bite fork is aligned and indexed to the top plate of the universal transfer device. The bite fork U-shaped plate aligns with corresponding grooves formed in the paste on the top plate of the universal transfer device. The bite fork is then properly oriented for preparation of the prosthesis.

The clutch transfer table can also have several dowel or alignment pins to index the universal transfer device to the table.

The clutch transfer device thus retains the correct alignment and orientation of the bite fork.

The clutch transfer table also eliminates the need to ship an articulator to the lab.

Other aspects of the invention will become apparent to those skilled in the art upon a reading and understanding of the following detailed description.

### BRIEF DESCRIPTION OF THE DRAWINGS

The invention may take form in certain components and structures, the preferred embodiments of which will be illustrated in the accompanying drawings wherein:

FIG. 1 is a perspective view showing the universal transfer device mounted on an articulator base along with the bite fork and clutch in accordance with a first embodiment of the present invention;

FIG. 2 is an exploded perspective view illustrating the universal transfer device in alignment with pegs on an articulating device and the bite fork and clutch aligned with an opening or hole in the articulating device in accordance with a first embodiment of the present invention;

FIG. 3 is a side elevational view in partial cross section illustrating the universal transfer device upper plate and ball joint in a pivoted position with a plaster-like material positioning the upper plate with the bite fork in accordance with a first embodiment of the present invention;

FIG. 4 is a top plan view illustrating the alignment of the bite fork and the upper plate of the transfer device in accordance with a first embodiment of the present invention;

FIG. 5 is a top plan view illustrating the ball and socket joint in the upper and lower plates of the universal transfer device in accordance with a first embodiment of the present invention;

FIG. 6 is a side elevational view of the universal transfer device in accordance with a first embodiment of the present invention;

FIG. 7 is a bottom plan view illustrating the base of the universal transfer device in accordance with a first embodiment of the present invention; and,

FIG. 8 is an exploded perspective view of the universal transfer device in accordance with a first embodiment of the present invention.

FIG. 9 is a clutch transfer device including a universal transfer device mounted to a clutch transfer table in accordance with a second embodiment of the present invention with a bite fork and clutch mounted to the clutch transfer table;

FIG. 10 is an exploded perspective view of the clutch transfer device assembly of FIG. 9;

FIG. 11 is a side elevational view in partial cross section illustrating the universal transfer device upper plate and ball joint in a pivoted position with a plaster-like material positioning the upper plate with the bite fork in accordance with a second embodiment of the present invention;

FIG. 12 is a bottom plan view of the universal transfer device in accordance with a second embodiment of the present invention;

FIG. 13 is a top plan view of the clutch transfer table of FIG. 9;

FIG. 14 is a top plan view of the clutch transfer table of FIG. 13; and

FIG. 15 is an end view, in partial cross-section, of the clutch transfer table of FIG. 13.

### DETAILED DESCRIPTION OF THE PREFERRED EMBODIMENTS

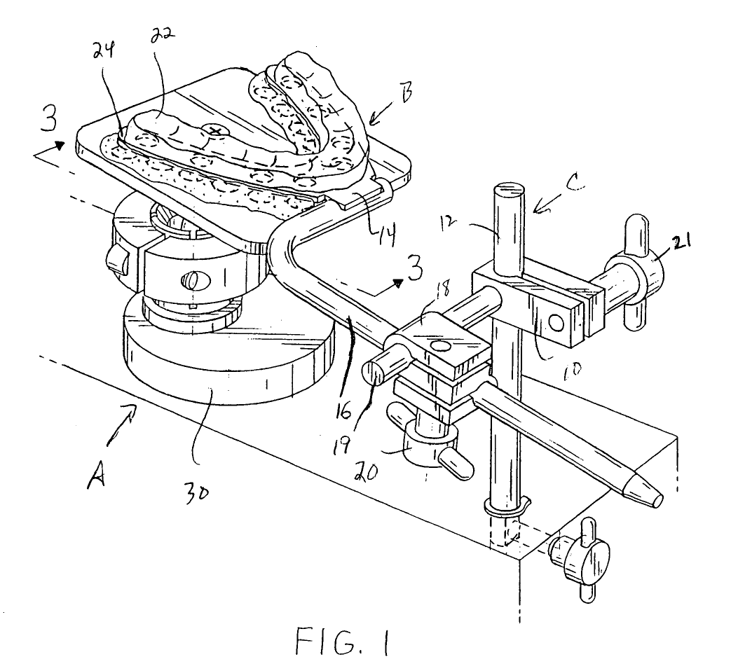

Referring now to the drawings, wherein the showings are for purposes of illustrating the preferred embodiments of this invention only and not for purposes for limiting same, FIG. 1 shows a universal transfer device A according to a first embodiment of the present invention. The universal transfer device is shown indexed to a bite fork B which is mounted onto a clutch C.

There are many proprietary articulator systems to which the present invention can be adapted. For example, a Denar™ articulator system or a Teledyne™ system can be used with the universal transfer device.

A face bow is used which includes a pair of substantially parallel side arms, and a linkage device which adjustably connects the arms to one another. Each of the arms have ear pieces at their opposite ends for suspension from the ears of the patient. The arms are curved such that in use the linkage device is positioned below the patient's mouth. The linkage device includes a bracket for supporting the clutch and bite fork. For example, refer to U.S. Pat. No. 4,634,377 for a conventional face bow. When the face bow is in the correct position on the patient, a central section of the bracket occupies the same spatial relationship to a reference point of the patient as the anterior end of the lower member of the articulator occupies to a reference plane of the articulator. Hence, a device such as a bite fork, would bear the same relationship to the teeth as it would to dental models.

Referring again to FIG. 1, a typical bite fork clutch consists of a block 10, a rod 12 adjustably fixed to the block, a bite fork 14 removably clamped to the rod by a stem 16 at a given level through an opening in mounting support 18 which is secured to the block 10 by rod 19. Clamps 20, 21 secure the bite fork to the clutch in vertical and horizontal orientations. A lower portion of the vertical rod 12 engages a slot (not shown) on the face bow.

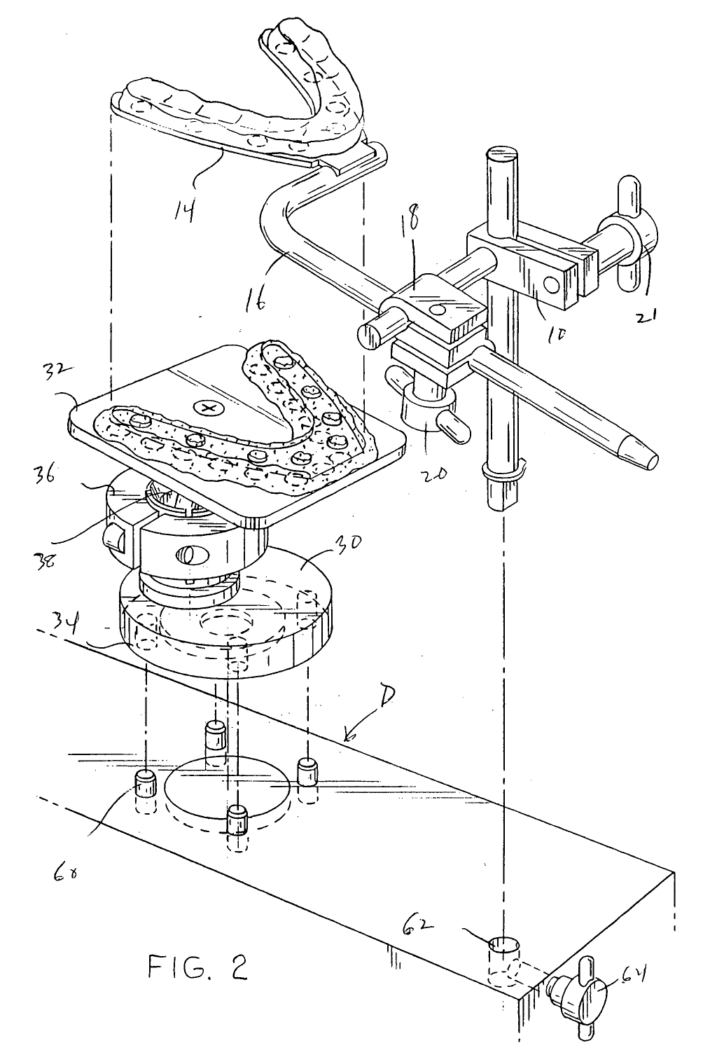

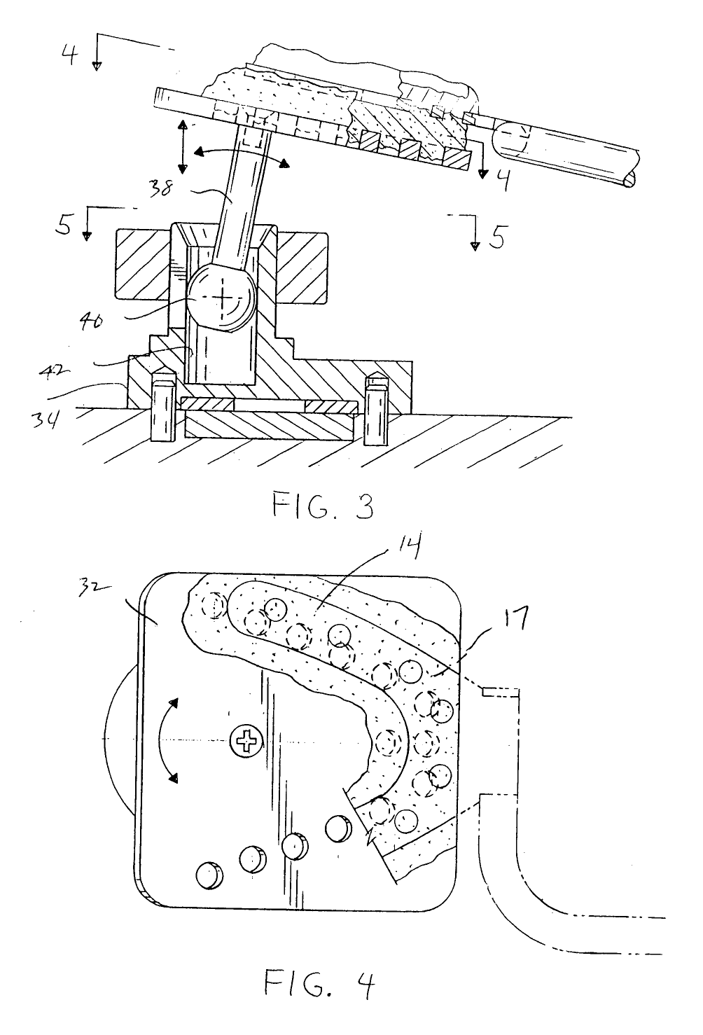

As seen in FIGS. 2 and 4, the bite fork 14 consists of a stem 16 and a U-shaped perforated plate 17 rigidly joined to the stem. The stem is round in section to fit a lower hole in the mounting support 18, in which it is fixed by the clamp mechanism 20. The bite fork with a horizontal perforated plate (as shown) may be used for most applications. Alternative bite forks with perforated plates may be tilt upwards or reverse downwards when a patient's occlusal plane is markedly tilted or antero-posteriorly.

In use, the clutch is mounted on the face bow. The face bow is fitted to the patient with ear plugs firmly inserted into external auditory meatuses and a suitable bite fork, adjusted to the patient's maxillary arch, is inserted in the mouth. The face bow is pivoted upward around the ear plugs until the stem of the bite fork contact the incisal edges of the maxillary central incisors or lies at a level which they should occupy. Several pieces or gobs of registration material, such as wax 22 are attached to a top surface 24 of the bite fork. The wax is bitten down on by the patient so that the paste or wax forms an impression of the patient's teeth onto the top surface of the bite fork. The face bow is held steady until the registration material sets, and the bite fork is removed from the patient and checked for a clear impression of the teeth.

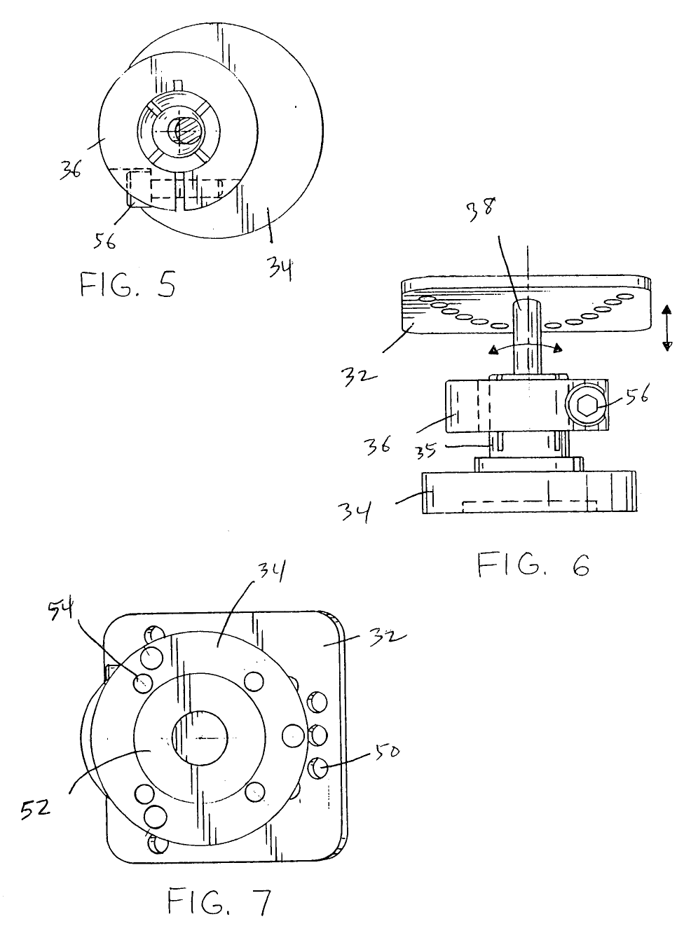

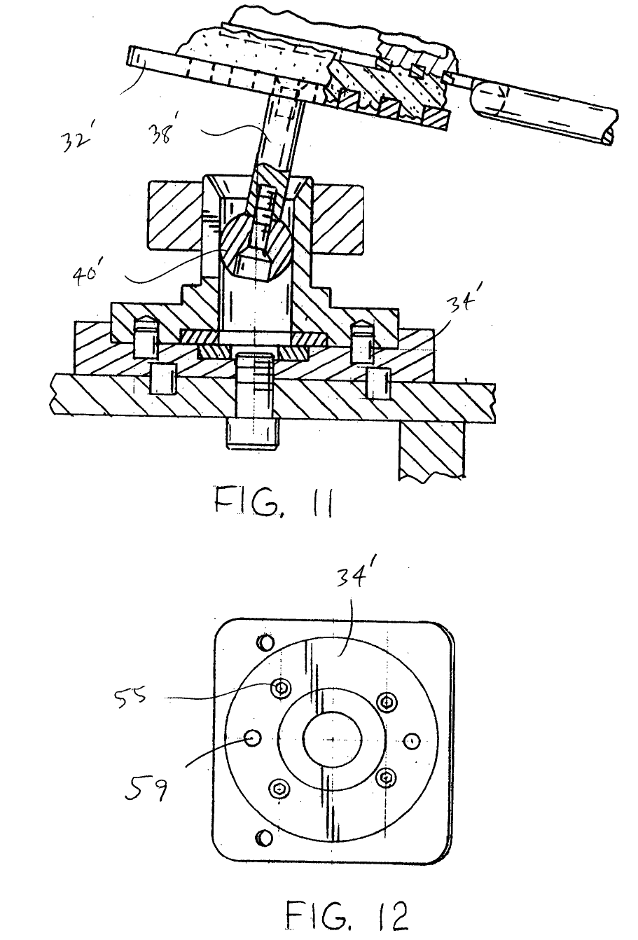

As seen in FIGS. 1 and 2, the bite fork clutch is then taken off the face bow and is aligned with a universal transfer device 30. Referring to FIGS. 2 and 5-8, the universal transfer device includes an upper plate 32, a lower plate or base 34, having a circular retaining block 36, and a stem 38 having a ball joint 40 which is inserted into an opening 42 in the stem 35 of lower plate 34. The universal transfer device is fabricated from aluminum or another suitable material. The ball 40 can be fabricated from aluminum or brass which can rotate easier with respect to an aluminum plate 34. The upper plate is attached to the stem via a screw 44. Referring to FIG. 3, the stem 38 and ball joint 40 are offset with respect to the center of upper plate 32. In a second embodiment, shown in FIG. 11, the stem 38′ and ball joint 40′ are centered with respect to the upper plate 32′.

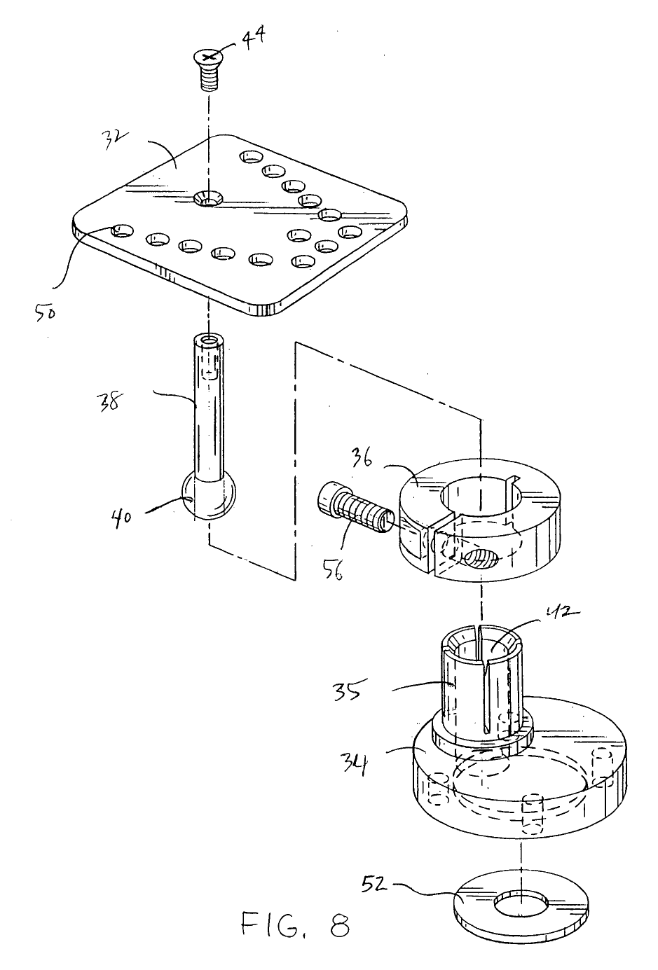

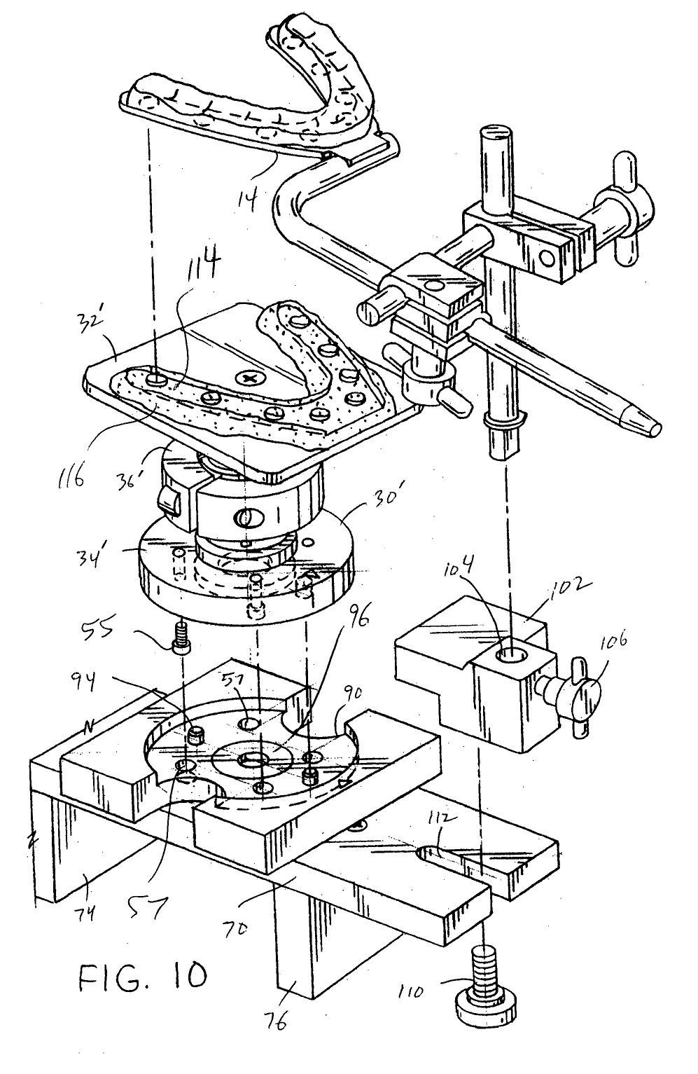

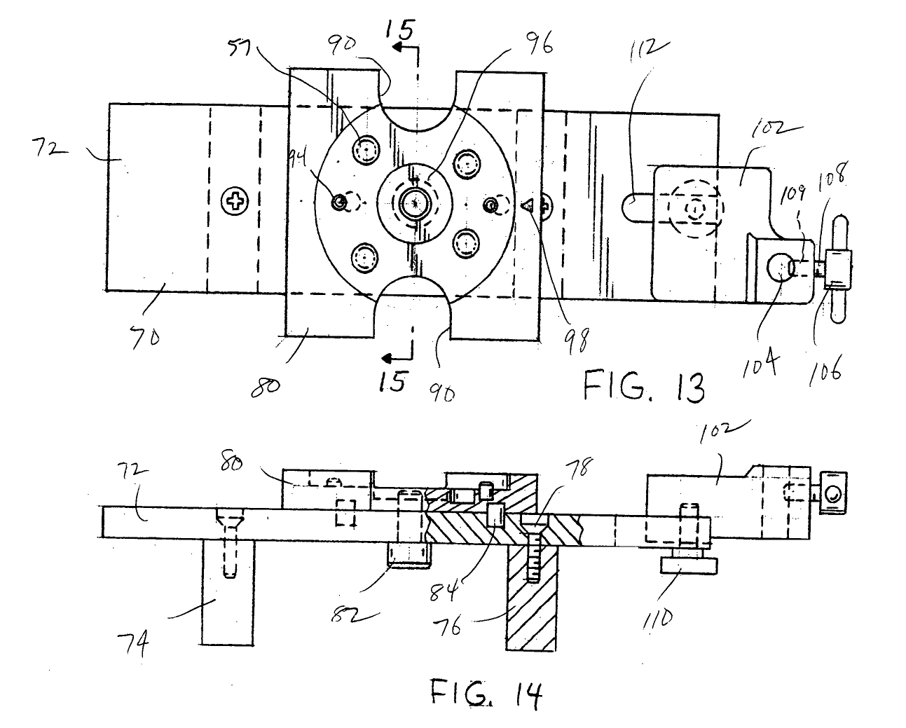

Plate 32 has a series of spaced apart holes 50 which form a semi-circular or triangular shaped perforated pattern about the edges of the plate. A magnet disk 52 is secured to an underside of the lower plate 34. The lower plate has a series of holes 54 as shown in FIG. 7 which are spaced apart in such a fashion as to allow alignment with pins or tabs in several different commercially available articulators. Thus, the spacing of the holes allows for the transfer device to have a universal application. Alternatively, in another embodiment of the device, the lower plate has several pins or screws 55 (FIGS. 10 and 12) which align with corresponding holes 57 (FIG. 13) in a clutch transfer device. As seen in FIG. 7, the holes in the base 32 are equally spaced apart. The base shown in FIG. 12 has pins or screws 55 which are unequally spaced apart. One pair of screws are closer together than the other pair of screws.

A screw 56 extends through a hole in the plate 36 and is used to tighten and clamp down the transfer device when the upper plate is in the proper orientation. Due to the universal ball joint, the upper plate may be tilted in horizontal, vertical and angled or rotational directions.

Referring now to FIG. 2, the universal transfer device is installed onto an articulator D aligning tabs or pegs 60 of the articulator with the holes 50 in the bottom of the bottom plate as well as the magnet 52 with a magnetized surface on the articulator. Rod 12 of the bite fork clutch is installed into a hole 62 in the articulator. A clamp 64 is then rotated to lock the bite fork clutch and bite fork into place.

After the universal transfer device is seated on the articulator, the upper plate is aligned with the underside of the bite fork as best seen in FIG. 2. Plaster or other securing material such as polyether paste is placed on the universal transfer device upper plate 32 and is used to index or align the bite fork with the universal transfer device upper plate. The universal transfer device is then indexed to the orientation of the bite fork using the universal ball joint. Once the upper plate is in the proper orientation and is properly indexed to the bite fork, the screw 56 is threaded to tighten down the retaining block 36 against the stem or rod and secure the transfer device upper plate in the proper orientation. The bite fork with clutch and the universal transfer device are then separated from each other and then are each shipped to a laboratory for mounting on an articulating device.

The magnet 52 and spacing of the holes 54 in the bottom plate allows for the universal transfer device to be mounted on virtually all of the major commercially available articulators. Thus, when the bite fork and transfer device arrive at the laboratory, the transfer device is then used to realign or index the bite fork as necessary to ensure that the bite fork is in the proper orientation when placed on the articulator. The universal transfer device is mounted onto the articulator as described above.

The bite fork is then aligned with the transfer device upper plate 32 and the plaster material on the upper plate is again used to align properly the bite fork with the upper plate grooves formed in the plaster corresponding to the U-shaped plate of the bite fork. Thus, any misalignment or shift or change in the indexed bite fork that may have occurred during shipment of the bite fork is corrected by aligning it with the transfer device plate.

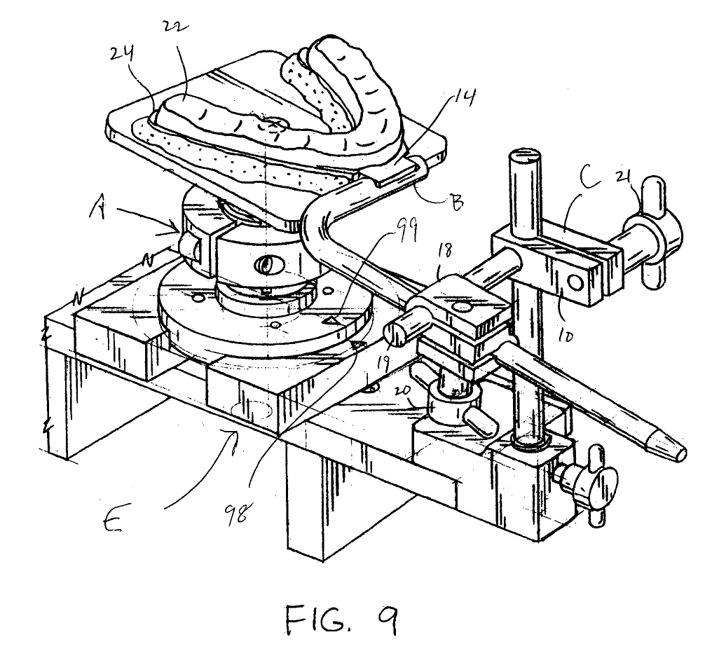

Alternatively, and in accordance with a second embodiment of the present invention, the universal transfer device and bite fork and clutch can be mounted onto a clutch transfer table E (FIG. 9). The clutch transfer table is used to duplicate the magnet and base of a specific model of an articulator, such as, for example, Denar™ or Teledyne™.

The clutch transfer table can be provided to a laboratory so that the articulator need not be shipped by the dentist to the lab.

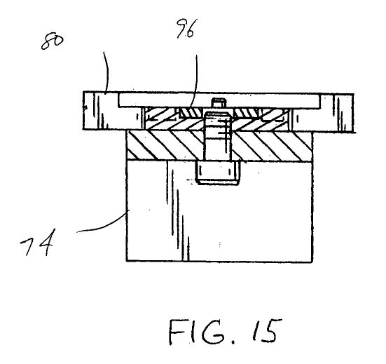

Referring to FIGS. 13-15, the clutch transfer table 70 has a plate 72 with two legs 74, 76 mounted thereto via screws 78 or other fastening means. The table can be made from aluminum or another suitable material. The legs can also be inserted into slots (not shown) milled into a bottom surface of plate 72. Alternatively, the legs and plate can be made of one piece. The legs typically are about four inches in length to ensure that the weight of the clutch and bite fork does not tip the table.

A top member or block 80 is mounted onto the plate via a screw or other fastening member 82. Several dowels or pins 84 are used to align the block 80 with plate 72.

Referring to FIG. 13, member 80 can have several finger grips or cut-outs 90 to facilitate installing a universal transfer device onto the table. Member 80 is shown to have a square configuration but other configurations, such as rectangular, can be used as well.

Four holes or openings 57 are provided in the member 80 to receive corresponding screws or pins 55 of the universal transfer device. Several dowels or pins 94 are positioned about 180° apart to align or index the universal transfer device to the table. The universal transfer device has holes 59 (FIG. 12) which align with the dowel pins. An arrow 98 is etched into the top member to further align the universal transfer device by aligning arrow 98 with arrow 99 (FIG. 9) on the universal transfer device.

A magnet 96 is provided on the top member to replicate a magnet on an articulator. An extension arm 102 is provided on one end of the table to receive and secure the clutch to the table. The arm 102 has a hole or opening 104 into which the clutch stem is inserted. A clamp member 106 having a horizontal member 108 is threaded into an opening 109 oriented 90° with respect to opening 104. The member 108 is threaded into the opening 104 to secure the clutch rod into place. The arm is secured to the table via a screw or pin 110 which can move or slide within a slot 112 and then be tightened into place to accommodate different positions for the clutch and bite fork.

Referring now to FIGS. 9 and 10, the universal transfer device is mounted onto the clutch transfer table by inserting the magnetic base of the device into the top member. The screws are inserted into holes in the top member, and the dowel pins align with holes in the device. Arrows 98, 99 are also aligned. Magnet 96 contacts magnet of the universal device.

The clutch and bite fork are inserted into hole 104 of the arm 102. The clamp 106 is rotated to secure the clutch into place. As described earlier, the bite fork is realigned or indexed to the upper plate of the universal device. Grooves 114 formed in the paste 116 align with the U-shaped plate of the bite fork. The bite fork proper orientation is reestablished at the lab using the clutch transfer table and the universal transfer device. Thus, an articulator is not required at the lab.

As mentioned earlier, the top member of the clutch transfer table duplicates the magnetic base of a specific articulator. Thus, separate clutch transfer tables would be provided for each model type of articulator.

The invention has been described with reference to the preferred embodiment. Obviously, alterations and modifications will occur to others upon a reading and understanding of the specification. It is intended to include all such modifications and alterations insofar as they come within the scope of the description hereabove.

In the claims:

1. A transfer device for use with a dental articulator, comprising:
a plate member;
a base member spaced apart from said plate member, said base member adapted to be received by said articulator;
a stem connected to said plate member and extending between said plate member and said base member;
a column extending from a first surface of said base member, wherein said stem is pivotally received in an opening of said column; and
a retaining block comprising a first opening for receiving said column, and a second opening disposed substantially perpendicular to said first opening for receiving a fastener.

2. The transfer device of claim 1, wherein said plate member further comprises a plurality of spaced apart holes extending through said plate member.

3. The transfer device of claim 1, wherein said plate member further comprises a hole for receiving a fastener and said stem comprises a threaded opening at a first end thereof for receiving said fastener.

4. The transfer device of claim 3, wherein said stem comprises a ball-shaped member extending from a second end opposite said first end thereof.

5. The transfer device of claim 4, wherein said column comprises spaced apart slots for allowing expanding of said column to receive said ball-shaped member of said stem.

6. The transfer device of claim 5, wherein said column comprises expandable material.

7. The transfer device of claim 1, wherein said retaining block comprises at least two slots approximately 90 degrees apart and formed adjacent said block first opening for allowing said block to expand to receive said column.

8. The transfer device of claim 7, wherein said second opening in said block extends through one of said slots formed in said block, wherein when said fastener is threaded through said second opening, said retaining block is compressed around said column and said at least two slots are compressed and are reduced in a widthwise direction.

9. The transfer device of claim 1, wherein said base member comprises at least one hole for receiving a pin extending from an associated articulator base.

10. The transfer device of claim 1, wherein said base member comprises a magnetized member.

11. The transfer device of claim 10, wherein said magnetized member comprises a circular magnet disc which engages a magnetized surface of an associated articulator base.

12. The transfer device of claim 11, wherein said magnet disc is received within a recess within said base member.

13. The transfer device of claim 10, wherein said base member comprises a plurality of holes spaced axially apart about the magnetized member.

14. The transfer device of claim 12, wherein said magnet disc is centrally positioned on said base member.

15. The transfer device of claim 10, wherein said base member comprises a circular shaped block.

16. The transfer device of claim 1, wherein said column is offset with respect to a central longitudinal axis of said base member.

17. The transfer device of claim 1, wherein said stem is pivotable in relation to said opening of said column.

18. In combination:
an articulator assembly comprising:
an articulator base comprising a plurality of pins oriented around a magnetized section;
a bite fork and jig assembly comprising:
a block,
an elongated member adjustably fixed to said block,
a bite fork comprising a U-shaped plate and a stem, said bite fork being removably clamped to said elongated member via a mounting support extending from said elongated member and receiving said stem, wherein said mounting support comprises a clamp assembly;
said base further comprising an opening for receiving said elongated member of said jig assembly;
a transfer device comprising:
a base member adapted to be received by said articulator base;
a plate member pivotally connected to said base member via a stem, said plate member adapted to align with and be removably secured to an underside of said bite fork plate; and
a retaining member which receives said stem and locks said plate member into a particular position.

19. The combination of claim 18, further comprising a plaster material which is applied onto said plate member for aligning and removably securing said bite fork U-shaped plate to said plate member.

20. The combination of claim 18, wherein said base member of said transfer device comprises a magnetized section which is received by said articulator base magnetized portion.

21. The combination of claim 18, wherein said transfer device further comprises a column extending from a first surface of said base member for pivotally receiving said stem of said transfer device.

22. The combination of claim 18, wherein said transfer device further comprises a retaining block for locking said stem in a particular position.

23. The combination of claim 18, wherein said plate member further comprises a plurality of spaced apart holes extending through said plate member.

24. The combination of claim 18, wherein said plate member further comprises a hole for receiving a fastener and said stem comprises a threaded opening at a first end thereof for receiving said fastener.

25. The combination of claim 18, wherein said stem comprises a ball-shaped member extending from a second end thereof opposite said first end thereof.

26. The combination of claim 18, wherein said column comprises spaced apart slots for allowing expanding of said column to receive said ball of said stem.

27. The combination of claim 18, wherein said column comprises expandable material.

28. The combination of claim 18, wherein said retaining block comprises at least two slots approximately 90 degrees apart and formed adjacent said block first opening for allowing said block to expand to receive said column.

29. The combination of claim 18, wherein said second opening in said block extends through one of said slots formed in said block, wherein when said fastener is threaded through said opening, said retaining block is compressed around said column and said slot is compressed and is reduced in a widthwise direction.

30. The combination of claim 18, wherein said base member comprises at least one hole for receiving at least one of said plurality of pins extending from said articulator base.

31. The combination of claim 20, wherein said magnetized section of said base member is received within a recess within said base member.

32. The combination of claim 20, wherein said base member comprises a plurality of holes spaced axially apart about the magnetized member.

33. The combination of claim 20, wherein said magnetized section of said base member is centrally positioned on said base member.

34. The combination of claim 18, wherein said base member comprises a circular shaped block.

35. The combination of claim 21, wherein said column is offset with respect to a central longitudinal axis of said base member.

36. The combination of claim 18, wherein said stem is pivotable in relation to said opening of said column.

37. A transfer device comprising:
an upper plate;
a lower plate connected to said upper plate via a stem;
said stem fastened to said upper plate and pivotally received by an opening in said lower plate; and
a retaining element for locking said stem and said upper plate in a particular position.

38. A clutch transfer device, comprising:
a plate;
a support member secured to said plate;
a magnetized member positioned on a first surface of said support member;
at least one pin received by at least one hole in said first surface of said support member; and
a recess formed in said first surface of said support member, said at least one hole and said magnetized member being positioned within said recess.

39. The clutch transfer device of claim 38, further comprising a plurality of holes spaced apart about said magnetized member.

40. The clutch transfer device of claim 38, further comprising at least one pair of legs extending from said plate.

41. The clutch transfer device of claim 40, wherein said legs are fastened to said plate via fasteners.

42. The clutch transfer device of claim 38, wherein said support member is secured to said plate via a fastener.

43. The clutch transfer device of claim 38, wherein said support member comprises a pair of finger grips for manually gripping said device.

44. The clutch transfer device of claim 43, wherein said finger grips are spaced 90 degrees apart.

45. The clutch transfer device of claim 38, further comprising a slot extending from an end of said plate.

46. The clutch transfer device of claim 38, wherein said support member further comprises an index mark adjacent said recess.

47. The clutch transfer device of claim 38, wherein said plate further comprises at least one pair of legs extending therefrom, wherein said plate and said legs are of one piece.

48. The clutch transfer device of claim 38, wherein said device is fabricated from metal.

49. The clutch transfer device of claim 38, wherein said support member has sides which protrude beyond sides of said plate.

50. The clutch transfer device of claim 38, further comprising a pair of pins spaced approximately 180 degrees apart wherein each of said pins is received by a corresponding hole in said support member.

51. The clutch transfer device of claim 38, further comprising at least one dowel for aligning said support member with a hole in said plate.
